(19) United States
(12) Patent Application Publication
(10) Pub. No.: US 2012/0006805 A1
(43) Pub. Date: Jan. 12, 2012

(54) LOW ELECTROMAGNETIC IMPACT DEVICE FOR HAIR DRYING AND HAIR CARE

(76) Inventor: Gianni Sani, Virgilio (IT)

(21) Appl. No.: 13/138,677

(22) PCT Filed: Jun. 19, 2009
(86) PCT No.: PCT/IT2009/000275

§ 371 Date: Sep. 19, 2011

(30) Foreign Application Priority Data
Mar. 25, 2009 (IT) MN2009U000001

(51) Int. Cl. A45D 20/12; B23P 17/00; A45D 20/46

(52) U.S. Cl. 219/222; 34/97; 34/99; 29/401.1

(57) ABSTRACT

Hair drying device comprising an electric motor unit to generate an air flow destined in use to hair drying and/or care, a support to hold the electric motor unit and a spacer duct, hollow inside so that the air flow emitted by the motor unit flows along the tube towards its exit section. The spacer duct has an overall L length at least equal or greater than a R1 distance in which the electromagnetic field emitted by the electric motor unit in use in the specific device measures an intensity at least equal or inferior to a pre-established threshold value of about 2 Milligauss.

### TECHNICAL FIELD

The present invention refers to the technical field of accessories for hair care. In particular, it refers to an innovative device for hair drying and/or hair treatment especially studied with the aim of minimizing as much as possible the impact on the user of the electromagnetic fields emitted as a consequence of the switching on of said device.

### BACKGROUND ART

Devices for hair care, commonly used for drying, straightening hair and other similar operations, are by now well-known. For example the hand-held hair dryer is by now used since long ago, which consists of a sort of pistol which can be activated in such a way that it emits an air flow that is potentially adjustable so that it can be hot or cold. To that purpose, a small electric motor activates a fan that generates the air flow and that the operator, for example the hairdresser, directs on the hairs in such a way that it dries and possibly comb them at the same time. Appropriate electric resistances can then be selectively activated so that they. conveniently heat the air flow that goes through them, in such a way that the exit temperature of the flow itself varies.

Other more complex devices are, for example, the bonnet or helmet hair dryer, which is used for covering entirely the user's head. Once positioned, the bonnet hair dryer can be programmed for a certain time so that it. emits, through a small electric motor positioned upstream the bonnet hair dryer itself, air flows at the desired temperature and also with a previously set humidity level. A uniform drying is thus operated.

However, even if said devices are by now commonly known and used, they are anyway invalidated by a significant technical inconvenient.

The air flow, either hot or cold, must be activated, as it has been said before, by a small motor of electric nature. This inevitably implies, in proximity of the small motor itself, the formation of electromagnetic fields that irradiate for a certain distance. In such sense, either the operator that manoeuvres, for example, the hand-held hair dryer, or the user on whom the operator makes the treatment is inevitably exposed to strong electromagnetic fields that are not beneficial to health. It is indeed known how electromagnetic fields cause disturbances, such as headaches. Moreover, in the case of long exposures, electromagnetic fields can favour the outbreak of pathologies much more serious, such as tumours.

Even though a private user limits himself to the use of such devices with a relatively low frequency and mainly connected with the specific moment of the care of his own hair, the use of such devices is anyway expected at least twice a week on average. It is thus evident that over the years said operations become innumerable, more or less repeated in a programmed manner, and such as to be able to cause health damage in the long run. In the case of an operator of the sector, for example the hairdresser, it is evident that he is immersed in such electromagnetic fields practically everyday, with very high frequencies and with easy-to-imagine consequences.

### SUMMARY OF THE INVENTION

It is therefore the aim of the present invention to give a device for hair drying that allows to resolve the above inconveniences.

In particular, it is the aim of the present invention to give a device for hair drying that allows to protect the person or persons that use it from the electromagnetic fields emitted by it as a consequence of its activation.

It is also the aim of the present invention to give a device that at the same time is light and easy to handle so that it does not weigh excessively on the user in general.

This and other aims are achieved by the present device (1) for hair drying comprising an electric motor unit (3) to generate an air flow destined in use to hair drying and/or care and wherein a support (2) to hold the electric motor unit and a spacer duct (4) are provided. The support therefore allows the person who is using the device to move away from the electromagnetic field emitted by the electric motor unit, not having the need of holding it anymore. The spacer duct (4), hollow inside and possibly integrated to or separated from the motor unit, allows the air flow emitted by the motor unit itself to flow along it towards its exit section (4″; 114″). Therefore, manufacturing the spacer duct (4) in a proper manner, it is possible to foresee that its L length results at least equal or major in respect of the R₁ distance in which the electromagnetic field emitted by the electric motor unit measures an intensity equal to a pre-established threshold value.

R₁ therefore indicates a specific spaciousness of the electromagnetic field generated by the motor unit in use on the device. It is in fact known how the intensity of the electromagnetic field rapidly decreases with the increase of the distance from the body that has generated it. In such a way, the R₁ limit can be chosen in such a way that at such a distance the electromagnetic field does not result dangerous for human health.

In such a manner, establishing such a minimum threshold value of the intensity of magnetic field so that it does not cause damage to human health, the length of the duct will be consequently obtained. The duct, when applied or made integrally on the motor unit, conducts and emits the air flow outside R₁, that is to say, outside the danger zone in which the intensities of the electromagnetic field are too high.

Generally, research in this regard has proven a pre-established minimum threshold value of the electromagnetic field of about 2 Milligauss or, naturally, inferior values. It can be therefore assumed how equal or inferior intensities of electromagnetic fields are essentially harmless for human health.

The user, being the electric motor unit held spaced by using the support and the duct, can therefore take advantage of the air flow for drying without being immersed in the dangerous action range of the field, therefore in total safety.

Advantageously, the spacer duct (4) is a spacer tube (4) comprising:
One attaching section (4′) to allow the connection in correspondence with the motor unit (3);
One exit section (4″) of the air flow.

In such case, the tube is thus an element detachable from the electric motor unit.

Alternatively, the spacer duct (4) is a proboscis integrated in a single piece to the electric motor unit. In such case, it is therefore undetachable.

In both solutions, integrated or detachable, the spacer duct (4) can possibly be made in a rigid first part (13) and a flexible second part (14).

The flexible part has therefore the advantage of resulting easily foldable in such a way that it allows the operator or user in general to orientate it in the most convenient possible manner during the drying operation.

To that purpose, the flexible part comprises a handle (6). Moreover, without moving away from the present inventive concept, nothing would impede the making of a duct (4) entirely of flexible type.

Alternatively, the second part (14) can be an independent flexible duct (114) comprising an attaching section (114′) to the first part.

In all the solutions described, the spacer duct (4) is provided on it with an indicative signal (5) of the R₁ distance in which the electromagnetic field reaches the above-mentioned pre-established threshold value.

The manufacturing of the duct is therefore connected with the electric motor unit used in the specific device. In such a way, the user has a practical idea of the safety distance to be kept.

Advantageously, in all the embodiments described, the spacer duct (4) is provided with activation means (16) to control, possibly remotely, the switching on and switching off of the electric motor unit (3).

Advantageously, it is further provided a bonnet or helmet hair dryer diffuser (15) comprising an attaching section to allow its connection to the spacer duct (4).

Advantageously, the support (2) is essentially upside-down-L-shaped and comprises a vertical arm (9) and a traverse beam (10).

In a possible embodiment the vertical arm (9) can be telescopic so that it allows height adjustment in respect of the ground. Alternatively, the arm can be fixed.

Moreover, the vertical arm (9) can also be provided of a base trolley (11) with wheels (12) to allow the movement of the entire drying device.

Advantageously, the electric motor unit (3) comprises:
At least one electric motor;
At least one fan activated by the electric motor to generate the air flow;
A supporting frame (7) comprising an exit mouthpiece (8) of the air flow generated by the fan.

Advantageously, the electric motor unit further comprises at least one electric resistance to increase the temperature of the air flow going out.

Advantageously, the electric motor unit is soundproof.

Last, a method to modify a traditional device is here further described, for example a traditional hand-held hair dryer or a bonnet hair dryer, to operate hair drying and comprising the operations of:
Arrangement of a support (2);
Connection of the traditional device to the support;
Connection of a spacer duct (4) to the traditional device so that the air flow emitted by the device flows along the duct (4) towards its outlet section and in which the spacer duct is configured so that it has an L length at least equal or major in respect of the R₁ distance in which the electromagnetic field emitted by the electric motor unit in use in the traditional device measures an intensity equal to a pre-established threshold value.

Also in such case, naturally, the minimum threshold value can be generally estimated in about 2 Milligauss.

### BRIEF DESCRIPTION OF THE DRAWINGS

Further characteristics and the advantages of the present hair drying device, according to the invention, will be more clearly seen with the description that follows of one or more of its embodiments, made for illustration purposes but not with limiting purposes, with reference to the annexed designs, in which:

FIG. 1 schematically describes the present device with duct 4 detached and the support for the electric motor unit.

FIG. 2 schematically represents the condition in which the duct is connected or is anyway integrated to the electric motor unit.

FIGS. 3 and 4 represent solutions in which the duct has a flexible part;

FIG. 5 shows accessories that can be connected to the duct, i.e. a bonnet or helmet hair dryer diffuser and a further tube.

FIG. 6 shows an example of use.

### DESCRIPTION OF SOME PREFERRED EMBODIMENTS

With reference to the attached figures, a device 1 for hair drying in accordance with the present invention is described.

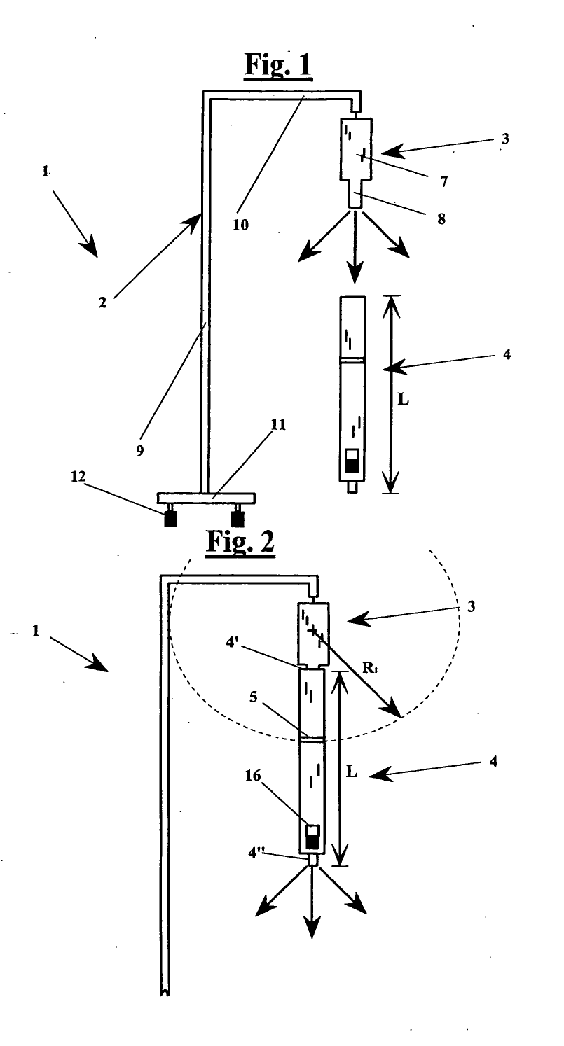

With particular reference to FIG. 1, a support 2 is destined in use to hold an electric motor unit 3 through which an air flow is generated and emitted (the arrows in FIG. 1 that come out from the electric motor unit approximately indicate the air flow). A supporting frame 7 (simply schematised in FIG. 1) lodges inside the electric motor unit and comprises an exit mouthpiece 8 through which the air produced flows. The electric motor unit comprises therefore an electric motor fed by the domestic electric network, which causes the rotation of a fan that generates the air flow. The electric motor and the fan are not represented in the detailed figure since the electric motor unit 3 described is absolutely equivalent to a well-known common hand-held hair dryer, not object of the present invention. Some electric resistances (one or more than one) can then be further provided within frame 7 with the aim of heating to the desired temperature the air flow coming out. In addition, a soundproof system can be provided, for example, inside frame 7, so that the noise effects of the device are minimized. The soundproof system can therefore comprise an inner coating suitable for absorbing the noise emitted by the motor.

The support element 2, in a first possible embodiment, is therefore constituted of an upside-down-L-shaped arm 2. This comprises therefore a vertical arm 9 emerging from the ground and a traverse beam 10 to which the electric motor unit 3 is hanged. The vertical arm 9 can be fixed or telescopic so that it allows easy height adjustment. Moreover, the arm 9 itself, either telescopic or fixed, can possibly be leant on a fixed base trolley 11 or on a base trolley 11 comprising wheels 12 so that it results in such case easily movable as needed.

Other support solutions can be proposed in an equivalent manner and comprising not necessarily a portable arm. For example, solutions of connection with hangers fixed to the wall at a predetermined height allow to fix the motor unit to the corresponding height from the ground. Alternatively, different supports, for example fixed to the floor as well, can be made for equally valid operations.

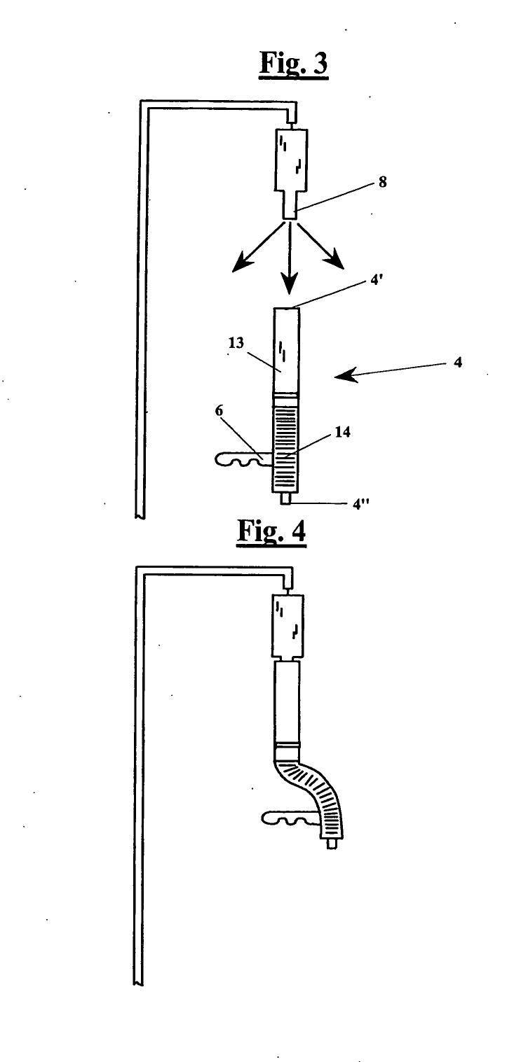

A spacer duct 4 (see also FIG. 2 for that purpose) of a predetermined L length allows the passage of the air flow from the electric motor unit towards its exit section 4″. In accordance with the present invention, therefore, the spacer duct 4 has an overall L length at least equal or major in respect of the R₁ distance in which the electromagnetic field emitted by the specific electric motor unit used in the device decreases to the threshold value of about 2 Milligauss or, naturally, inferior values.

In a first possible embodiment of the invention, the duct is constituted of a spacer tube 4 (see FIG. 2 for that purpose), naturally hollow inside, to allow the passage of the air flow, comprising an attaching section 4′ in correspondence with the motor unit 3 and an exit section. 4″ through which the air flow that passes through it comes out. In particular, FIG. 2 schematises the connection of the spacer tube 4 in correspondence with the exit mouthpiece 8 of frame 7.

In a possible embodiment variant of the spacer tube (see FIG. 3 for that purpose), it can be constituted by a more rigid first part 13, destined in use to the connection to the mouthpiece 8 through the attaching section 4′, and a flexible second part 14 comprising a manoeuvring handle 6. In such a manner, as highlighted in FIG. 4, the handle allows to bend and direct the flexible part of the tube with great ease. The handle 6, along with the exit section 4″, can then be assembled in a rotatable idle manner in respect of the flexible tubular body 14, so as to facilitate its use.

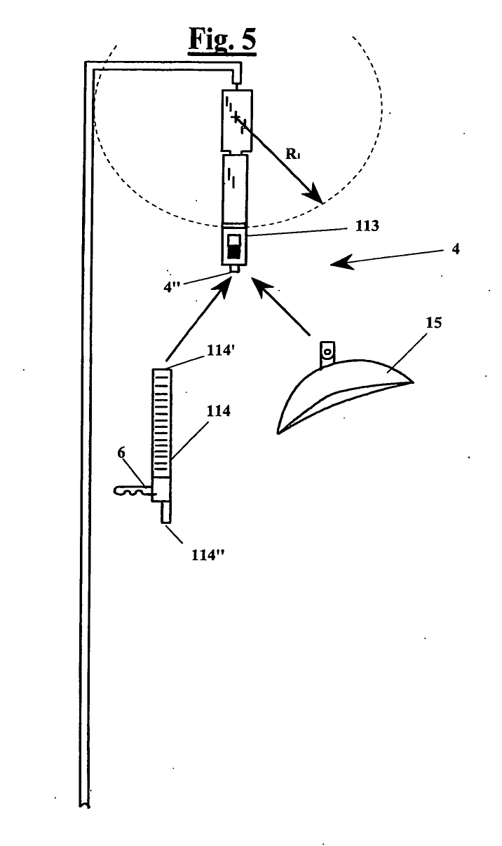

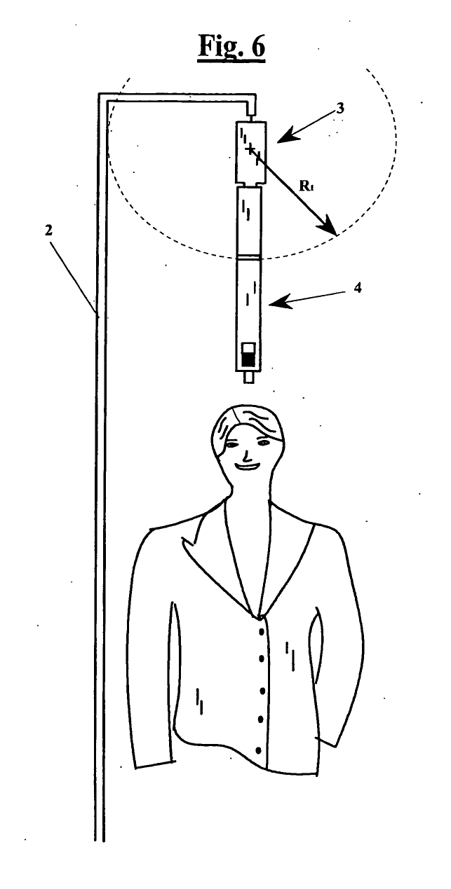

Alternatively (see FIG. 5), the spacer tube 4 can comprise a first part 113 and a second part 114 constituted by an independent flexible duct 114. In such case, the hollow flexible duct 114 also comprises an attaching section 114′ so that it can be connected to the exit section 4″ of the first part 113. An exit section 114″ allows the final coming out of the air flow from the flexible tube in accordance with the predetermined direction. Also in such case, a handle 6 assembled idle in respect of the tube 114 allows the operator to direct the tube 114 at will in an easy way.

A second embodiment, instead, provides a proboscis with spacer duct functionality, made integrated and not detachable from the electric motor unit. In such case, apart from the attaching section not present being the proboscis integrated, such proboscis is absolutely identical and equivalent to what has been previously described.

In all the described configurations, the spacer duct is further provided, at a predetermined distance in respect of the electric motor unit, with a signal 5 that visibly indicates the R₁ radius, or distance, in which such electromagnetic field emitted by the electric motor unit 3 in use in that specific device has decreased to the value of about 2 Milligauss (or values inferior if these are chosen as preferred thresholds for more safety). Such indication can serve as visual reference to the user. Each duct will be therefore specifically manufactured according to the motor unit used and with which it will be used.

Last, in all the described configurations, the duct can be provided with activation means 16 to control the switching on and the switching off of the electric motor unit 3. These can comprise simple ON/OFF buttons operated manually and prearranged at any point of the duct, for example, also in proximity of the air exit mouthpiece. In addition, the activation solution by way of a remote control can be integrated.

Alternatively, the flexible tube 114 can be substituted by a simple helmet 15 connected to the exit section 4″ of the spacer duct 4 in all the described configurations.

Having described the invention in its essential technical features, with reference to FIG. 6 we pass on to a description of a possible example of use in the specific but not limiting case of the support arm 2. Different supports imply a totally equivalent functionality.

The support 2 keeps the motor unit far from the user that makes use of the air flow thanks to the'spacer tube 4. As per what described above, since the L length of the tube 4 is predefined so that it is at least equal or major in respect of the R₁ distance in which the electromagnetic field emitted by the motor in use is radially decreased to a value of at least 2 Milligauss, the user will therefore find himself outside such danger zone. In such case, either the operator that performs the drying or the “client” to which the drying is being done will be totally protected from the impact of the electromagnetic fields of high intensity and dangerous for health. The signal 5 visually facilitates the location of the risk zone and the safe zone.

It is therefore evident at this point how all the goals set for the present invention have been reached. In particular, it is evident how the spacer duct 4 keeps users in general away from the dangerous range of the electromagnetic field generated by the motor-resistance unit. Moreover, on the duct, the signal 5 relative to the extension zone of the electromagnetic field allows to easily identify which the correct displacement of the device should be so that the field does not affect the people nearby. This can be therefore obtained with a possible height adjustment of the telescopic arm.

Moreover, being the device held by the support, the weight on the hand, the arm and the back of the operator is limited to the few grams of the air mouthpiece. This entails a great work saving, thus also reducing superior articulations problems. Moreover, since the motor is positioned outside the user's operative space, it follows that neither the electric cables interfere with the work.

The description above of a specific embodiment is capable of showing the invention from the conceptual point of view so that others, using the state-of-the-art, will be able to modify and/or adapt in different applications such specific embodiment without further research or without moving away from the inventive concept and therefore it is understood that such adaptations and modifications will be considered as equivalent to the specific embodiment. The means and the materials to make the different functions described may be of various nature if within the invention's sphere. It is understood that the expressions or the terminology used have a purely descriptive aim and are therefore not limiting.

1-18. (canceled)

19. Hair drying device comprising:
an electric motor unit to generate an air flow destined in use to hair drying and/or care;
a support to hold said electric motor unit;
a spacer duct, hollow inside so that the air flow emitted by said motor unit flows along the duct towards its exit section;
and wherein said spacer duct has an overall L length at least equal or greater than a R₁ distance in which the electromagnetic field emitted by said electric motor unit measures an intensity equal to a pre-established threshold value.

20. Hair drying device, according to claim 19, wherein said pre-established threshold value of the electromagnetic field is at least equal or inferior to the value of 2 Milligauss.

21. Hair drying device, according to claim 19, wherein said spacer duct is a spacer tube that comprises:
an attaching section to allow the connection in correspondence with the motor unit;
an exit section of the air flow.

22. Hair drying device, according to claim 19, wherein said spacer duct is a proboscis integrated in a single piece to the electric motor unit.

23. Hair drying device, according to claim 19, wherein said spacer duct comprises a first rigid part and a second flexible part.

24. Hair drying device, according to claim 23, wherein said flexible part comprises a handle.

25. Hair drying device, according to claim 23, wherein the handle is assembled idle in respect of said flexible part.

26. Hair drying device, according to claim 23, wherein said second part is an independent flexible tube comprising an attaching section to the first part.

27. Hair drying device, according to claim 19, wherein said spacer duct is provided with at least an indicative signal of the R₁ distance in which said electromagnetic field reaches said pre-established threshold value.

28. Hair drying device, according to claim 19, wherein said spacer duct is provided with activation means to control the switching on and switching off of said electric motor unit.

29. Hair drying device, according to claim 19, wherein said support is substantially upside-down-L-shaped and comprises a vertical arm and a traverse beam.

30. Hair drying device, according to claim 29, wherein said vertical arm is telescopic so that it allows height adjustment in respect of the ground.

31. Hair drying device, according to claim 29, wherein said vertical arm is provided with a base trolley with wheels to allow the movement of the entire hair drying device.

32. Hair drying device, according to claim 19, wherein it is further provided a helmet hair dryer diffuser comprising an attaching section to allow its connection to the spacer duct.

33. Hair drying device, according to claim 19, wherein said electric motor unit comprises:
at least one electric motor;
at least one fan activated by said electric motor to generate said air flow;
a support frame comprising an exit mouthpiece of the air flow generated by said fan.

34. Hair drying device, according to claim 33, wherein said electric motor unit further comprises at least an electric resistance to increase the temperature of the air flow.

35. Hair drying device, according to claim 19, wherein said electric motor unit is soundproofed.

36. Method to modify a traditional device to operate hair drying and comprising the steps of:
arranging a support;
connecting said traditional device to said support;
connecting a spacer duct to said traditional device so that the air flow emitted by said device flows along the duct towards its exit section, said spacer duct being configured such that it has an L length at least equal or greater than a R₁ distance in which the electromagnetic field emitted by the electric motor unit in use in said traditional device measures an intensity equal to a pre-established threshold value.
